(19) United States
(12) Patent Application Publication
(10) Pub. No.: US 2021/0117001 A1
(43) Pub. Date: Apr. 22, 2021

(54) HAPTIC FEEDBACK CAPTURING DEVICE AND A METHOD THEREOF

(71) Applicant: Zensar Technologies Limited, Pune (IN)

(72) Inventor: Murali Krishna KADAMBI, Pune (IN)

(21) Appl. No.: 16/719,398

(22) Filed: Dec. 18, 2019

(30) Foreign Application Priority Data
Oct. 16, 2019 (IN) 201921041905

(51) Int. Cl. G06F 3/01; G06F 1/16

(52) U.S. Cl. CPC G06F 3/016; G06F 2203/014; G06F 3/011; G06F 1/163

(57) ABSTRACT

A haptic feedback capturing device and a method thereof is disclosed. The haptic feedback capturing device may include a plurality of electromagnets and a plurality of permanent magnets arranged in form of a matrix. Each cell in the matrix may include one or more electromagnets, of the plurality of electromagnets, and a permanent magnet of the plurality of permanent magnets. The matrix may be communicatively coupled with a communication device. The haptic feedback capturing device receives an activation signal from the communication device and activate the at least one coil based upon the activation signal. The permanent magnet may be repelled from the core of the at least one activated coil or from the at least one activated coil and touch the skin of the user to generate sensation of touch thereby capturing the haptic feedback.

### CROSS-REFERENCE TO RELATED APPLICATIONS AND PRIORITY

The present application claims priority from Indian Patent Application no. 201921041905 filed on the 16 Oct. 2019, the details of which are incorporated herein by a reference.

### TECHNICAL FIELD

The present subject matter described herein, in general, relates to a haptic feedback capturing device and a method thereof.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Virtual reality enables in providing a possibility to interact with a virtual environment. The virtual reality consists of software and hardware technologies which interact with the user to immerse him/her in the virtual environment. Objects in the virtual environment are perceived through technology acting on human senses. These technologies are constituted of visualization devices, haptic feedback, sound feedback, tactile and force feedback, as well as motion platform, for example.

In the field of Virtual Reality or Augmented reality, haptic feedback or haptics is the deployment of vibration or pressure to engage your sense of touch when using technology. The users can see virtual objects and may even feel them when they bump up against them. Currently, the wearable surfaces or systems such as gloves, or controllers are used in order to allow the wearer to manipulate a virtual hand, perform an action associated with virtual objects in the virtual reality and feel its shape.

In an air-bubble based haptic feedback system, each VR glove comprises a flat little air pocket encased in a thin silicone skin. By varying the air pressure in the pocket, an air bubble is formed as the shape of the silicone is changed. Varying the signal changes the height of the bubble, and the signals can be turned ON and OFF instantly reflecting corresponding changes in the air pressure in the air bubble. It should be noted herein that little air bubble is the key to feeling the sense of touch. The user feels the touch based upon the change in the height of the air bubble.

In the vibration based haptic feedback system, each VR glove comprises of a resonant actuator to detect virtual objects and provide haptic feedback to the glove. When the virtual hand touches the virtual objects, the glove presents vibration stimuli corresponding to the contact site thereby providing a haptic feedback.

Further, few of the existing VR/AR technologies use vibrating motors for capturing the haptic feedback. More specifically, the vibrating motors are placed in handheld remotes and videogame controllers. In video games for example, when there are events in the games being played (for example, any virtual explosions, bumping into virtual objects, touching virtual objects etc.), vibrations are sent to indicate these events. However, the existing system has limitation of body part which can interface with the virtual world. Further, the existing system are not compatible with other wearable or dynamic surfaces.

### SUMMARY

This summary is provided to introduce concepts related to a haptic feedback capturing device and a method thereof and the concepts are further described below in the detailed description. This summary is not intended to identify essential features of the claimed subject matter nor is it intended for use in determining or limiting the scope of the claimed subject matter.

In one embodiment, a haptic feedback capturing device is disclosed. The haptic feedback capturing device may comprise a plurality of electromagnets and a plurality of permanent magnets arranged in form of a matrix, wherein each cell in the matrix may comprise one or more electromagnets, of the plurality of electromagnets, and one or more permanent magnets of the plurality of permanent magnets. The matrix may be communicatively coupled with a communication device. A coil associated to each electromagnet corresponding to each cell in the matrix may comprise of a core. At least one coil in the matrix may be configured to be activated upon receipt of an activation signal from the communication device. The at least one coil activated may create a repulsive force between the at least one electromagnet and the permanent magnet belonging to the cell corresponding to at least one coil activated. The permanent magnet may be repelled from the core of the at least one activated coil and touch the skin of the user in order to generate sensation of touch thereby capturing the haptic feedback.

In another embodiment, a method for capturing haptic feedback is disclosed. The method may comprise configuring, on a haptic feedback capturing device, a matrix of a plurality of electromagnets and a plurality of permanent magnets, wherein each cell in the matrix may comprise one or more electromagnets, of the plurality of electromagnets, and one or more permanent magnets of the plurality of permanent magnets. The matrix may be communicatively coupled with a communication device. A coil associated to each electromagnet corresponding to each cell in the matrix may comprise a core. The method may comprise receiving, by the haptic feedback capturing device, an activation signal from the communication device. The method may further comprise of activating, by the haptic feedback capturing device, at least one coil based upon the activation signal. The at least one coil activated may create a repulsive force between at least one electromagnet and the permanent magnet belonging to the cell corresponding to the at least one coil activated. The permanent magnet may be repelled from the core of the at least one activated coil and touch the skin of the user in order to generate sensation of touch thereby capturing the haptic feedback.

In yet another embodiment, a haptic feedback capturing device is disclosed. The haptic feedback capturing device may comprise a plurality of electromagnets and a plurality of permanent magnets arranged in form of a matrix, wherein each cell in the matrix may comprise one or more electromagnets, of the plurality of electromagnets, and one or more permanent magnets of the plurality of permanent magnets. The matrix may be communicatively coupled with a communication device. At least one coil associated to each electromagnet corresponding to each cell in the matrix may configured to be activated upon receipt of an activation signal from the communication device. The at least one coil activated may create a repulsive force between the at least one electromagnet and the permanent magnet(s) belonging to the cell corresponding to at least one coil activated. The permanent magnet(s) may be repelled from the at least one activated coil and touch the skin of the user in order to generate sensation of touch thereby capturing the haptic feedback.

In still another embodiment, a method for capturing haptic feedback, is disclosed. The method may comprise configuring, on a haptic feedback capturing device, a matrix of a plurality of electromagnets and a plurality of permanent magnets, wherein each cell in the matrix comprises one or more electromagnets, of the plurality of electromagnets, and one or more permanent magnets of the plurality of permanent magnets. The matrix may be communicatively coupled with a communication device. The method may comprise receiving, by the haptic feedback capturing device, an activation signal from the communication device. The method may comprise activating, by the haptic feedback capturing device, at least one coil associated to each electromagnet corresponding to each cell in the matrix based upon the activation signal. The at least one coil activated may create a repulsive force between at least one electromagnet and the permanent magnet(s) belonging to the cell corresponding to the at least one coil activated. The permanent magnet(s) may be repelled from the at least one activated coil and touch the skin of the user in order to generate sensation of touch thereby capturing the haptic feedback.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of a haptic feedback capturing device(s) 104, in accordance with an embodiment of the present subject matter.

FIGS. 2A and 2B illustrates the haptic feedback capturing device 104, in accordance with a first embodiment of the present subject matter.

FIGS. 3A and 3B illustrates the haptic feedback capturing device 104, in accordance with a second embodiment of the present subject matter.

FIG. 4 illustrates a method 400 performed by the haptic feedback capturing device 104 for capturing haptic feedback, in accordance with the first embodiment of the present subject matter.

FIG. 5 illustrates a method 500 performed by the haptic feedback capturing device 104 for capturing haptic feedback, in accordance with the second embodiment of the present subject matter.

FIGS. 6A and 6B illustrates an activation of at least one coil, in accordance with an embodiment of the present subject matter.

FIG. 7 illustrates an implementation of the haptic feedback device 104 in a display device for displaying braille to braille users, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

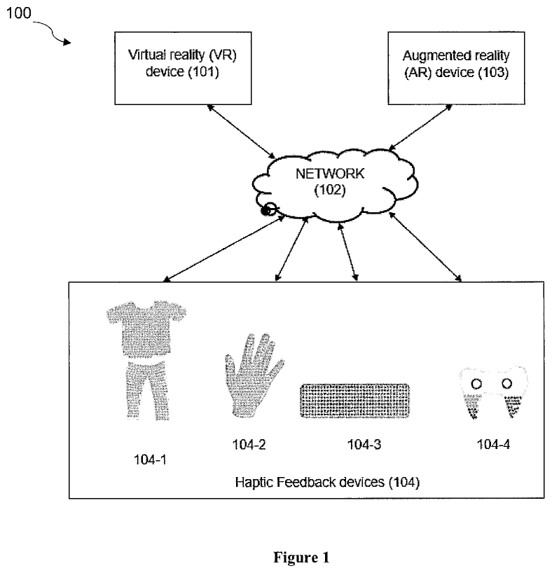

The present application relates to a haptic feedback capturing device. In accordance with various embodiments of the present subject matter, the haptic feedback capturing device may enable a user to feel an object and its textures present in a Virtual Reality (VR) or Augmented Reality (AR) environment, thereby enhancing the user experience. Referring to FIG. 1, a network implementation 100 of a haptic feedback capturing device 104 is illustrated, in an accordance with an embodiment of the present subject matter. The haptic feedback capturing device 104 may comprise a plurality of electromagnets and a plurality of permanent magnets arranged in form of a matrix (not shown in FIG. 1). In accordance with various embodiments of the present subject matter, each cell in the matrix may comprise of one or more electromagnets, of the plurality of electromagnets, and a permanent magnet of the plurality of permanent magnets. In one embodiment, the number of electromagnets and/or the permanent magnets of the matrix may determine the granularity of textures. The granularity of the textures may be felt on the haptic feedback capturing device 104. In one embodiment, the haptic feedback capturing device 104 may be a wearable surface including, but not limited to, a clothing 104-1, a hand glove 104-2, a display device for displaying braille 104-3, a video game remote controller 104-4, and the like.

In one embodiment, the plurality of electromagnets and the plurality of permanent magnets arranged in matrix may be represented as “magnetic pixels”, hereinafter also referred to as “Maxels”. In one embodiment, the matrix is implemented in the wearable surface. In one exemplary embodiment, the wearable surface may be the hand glove 104-2. In one embodiment, the matrix may be communicatively coupled with a Virtual Reality (VR) device 101. In another embodiment, the matrix may be communicatively coupled with an Augmented Reality (AR) device 103. In one implementation, the matrix may be connected to the Virtual Reality (VR) device 101 or the Augmented Reality (AR) device 103 through a network 102. In one embodiment, the matrix may receive information from the Virtual Reality (VR) device 101 or the Augmented Reality (AR) device 103. In one embodiment, the matrix may be connected to a display device 104-3 for displaying braille.

In one implementation, the network 102 may be a wireless network, a wired network or a combination thereof. The network 102 can be accessed by the Virtual Reality (VR) device 101 or the Augmented Reality (AR) device 103 using wired or wireless network connectivity means including updated communications technology. The network 102 can be implemented as one of the different types of networks, cellular communication network, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 102 may include a variety of network devices, including routers, bridges, servers, computing devices, storage devices, and the like.

The aforementioned devices may support communication over one or more types of networks in accordance with the described embodiments. For example, some computing devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1×RTT, GSM/GPRS, EDGE, HSDPA, HSUPA, and others.

The aforementioned devices and networks may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. Computing devices and networks also may support short range communication such as a wireless personal area network (WPAN) communication, Bluetooth® data communication, infrared (IR) communication, near-field communication, electromagnetic induction (EMI) communication, passive or active RFID communication, micro-impulse radar (MIR), ultra-wide band (UWB) communication, automatic identification and data capture (AIDC) communication, and others.

The present application provides two different embodiments of the haptic feedback capturing device 104 enabling capturing of haptic feedback, the details of which are explained hereinafter as below.

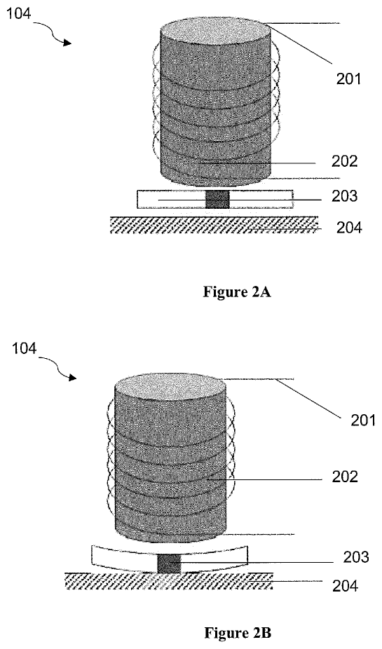

According to a first embodiment of the present application, the haptic feedback capturing device 104 is illustrated in FIGS. 2A and 2B. The haptic feedback capturing device 104 may comprise a plurality of electromagnets and a plurality of permanent magnets arranged in form of a matrix. FIG. 2A and FIG. 2B depicts one cell of the matrix. As shown, each cell in the matrix may comprise one or more electromagnets 201, of the plurality of electromagnets, and a permanent magnet 203 of the plurality of permanent magnets. In another embodiment, each cell in the matrix may comprise one or more electromagnets 201, of the plurality of electromagnets, and more than one permanent magnet 203 of the plurality of permanent magnets. The coil associated to each electromagnet corresponding to each cell in the matrix comprises a core 202. The core 202 may be made up of a suitable material that enhances the strength of magnetic field. In one example, the core 202 may be made of ferromagnetic material. In this embodiment, the permanent magnet 203 may be embedded in the wearable surface. In this embodiment, an insulating layer may be present between each electromagnet the permanent magnet. In an embodiment, one end of the coil associated to each electromagnet is closed and the other end is either touching the skin or close to the skin of the user. In one embodiment, the matrix may be positioned at same side of the wearable surface. In another embodiment, the matrix may be placed at both sides of the wearable surface.

At least one coil in the matrix may configured to be activated upon receipt of an activation signal from the communication device. In one embodiment, the communication device may be the Virtual Reality (VR) device 101 or the Augmented Reality (AR) device 103. In one embodiment, the activation signal may be indicative of an event from the Virtual Reality (VR) device 101 or the Augmented Reality (AR) device 103 (As shown in the FIG. 1). The event may represent one or more gestures performed by a user of the Virtual Reality (VR) device 101 or the Augmented Reality (AR) device 103. In one exemplary embodiment, one or more gestures may comprise touch or feel an object present in the Virtual Reality (VR) or the Augmented Reality (AR) environment. The at least one coil activated may create a repulsive force between the at least one electromagnet 201 and the permanent magnet(s) 203 belonging to the cell corresponding to at least one coil activated. The permanent magnet(s) 203 may be repelled from the core 202 of the at least one activated coil and touch the skin of the user 204 (As shown in FIG. 2B) in order to generate sensation of touch thereby capturing the haptic feedback. It must be noted herein that, like poles of magnets experience the repulsive force. The electric current flowing through the electromagnet may determine the magnetic field generated by the electromagnet, which determines the repulsive force. Therefore, variation in the electric current may control the repulsive force between the at least one electromagnet 201 and the permanent magnet 203 and that in turn translates to different amount of pressure sensations at a point of contact with the object present in the Virtual Reality (VR) environment or Augmented Reality (AR) environment.

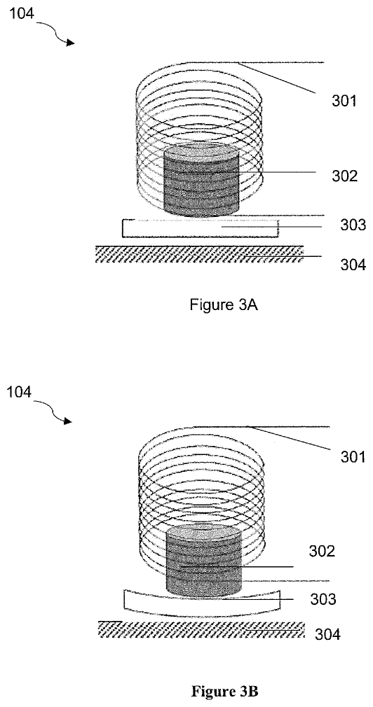

According to a second embodiment of the present application, the haptic feedback capturing device 104 is illustrated in FIGS. 3A and 3B. The haptic feedback capturing device 104 may comprise a plurality of electromagnets and a plurality of permanent magnets arranged in form of a matrix. FIG. 3A and FIG. 3B depicts one cell of the matrix. In one embodiment, each cell in the matrix may comprise one or more electromagnets 301, of the plurality of electromagnets, and a permanent magnet 302 of the plurality of permanent magnets. In another embodiment, each cell in the matrix may comprise one or more electromagnets 301, of the plurality of electromagnets, and more than one permanent magnet 302 of the plurality of permanent magnets. In one embodiment, a separation layer 303 may be present between the matrix of the plurality of electromagnets and the plurality of permanent magnets and skin of user. The permanent magnets may be placed as a layer between the electromagnet and the user's skin. The matrix may be communicatively coupled with a Virtual Reality (VR) device 101 or an Augmented Reality (AR) device 103.

In one embodiment, at least one coil associated to each electromagnet corresponding to each cell in the matrix is configured to be activated upon receipt of an activation signal from the communication device. In one embodiment, the communication device may be the Virtual Reality (VR) device 101 or the Augmented Reality (AR) device 103. In one embodiment, the activation signal may be indicative of an event from the Virtual Reality (VR) device 101. In this second embodiment, coil associated to each electromagnet is placed around or at close distance to each permanent magnet corresponding to a respective cell in the matrix. Further, it must be noted that arrangement of the electromagnets and permanent magnets may vary in the matrix. In one embodiment, the electromagnet may comprise a core (Not shown in the Figure), wherein the core contains a permanent magnet that may cause actuation of coil associated to each electromagnet upon activation. In another embodiment, each permanent magnet may be placed at different locations in the lower region of the coil, the lower region facing the skin of the user. In yet another embodiment, each permanent magnet may be placed below the lower region of the coil. It must be understood that the repulsive force may vary based upon placement of the permanent magnet at different locations in the lower region or below the lower region.

The event represents one or more gestures performed by a user of the Virtual Reality (VR) device 101 or the Augmented Reality (AR) device 103. In one embodiment, one or more gestures may comprise touch or feel an object present in the Virtual Reality (VR) or the Augmented Reality (AR) environment. The at least one coil activated may create a repulsive force between the at least one electromagnet 301 and the permanent magnet 302 belonging to the cell corresponding to at least one coil activated. The permanent magnet 302 may be repelled from the at least one activated coil and touches the skin of the user (As shown in FIG. 3B) in order to generate sensation of touch thereby capturing the haptic feedback.

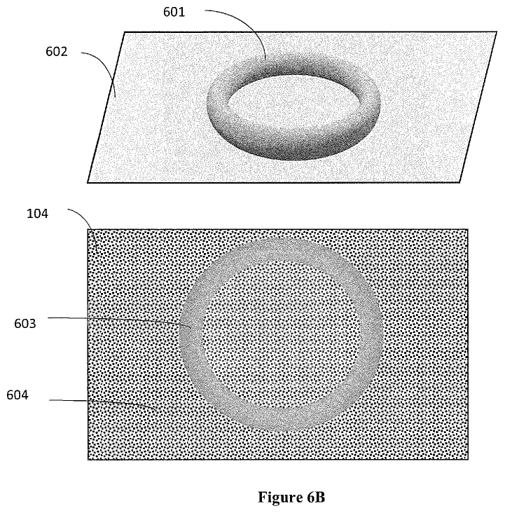

Now referring to FIGS. 6A and 6B an activation of at least one coil associated to each electromagnet, in accordance with an embodiment of the present subject matter is illustrated. As shown in the FIG. 6A, 3D object 601 in the virtual environment 602 about to interact with the user. The communication device may be configured to determine a location of one or more electromagnets of the plurality of the electromagnets, a location of one or more permanent magnets of the plurality of the permanent magnets of the matrix, which need to be activated based upon the interaction of the user with 3D object 601 in the virtual environment 602. The communication device or the VR/AR system may be configured to determine the location of one or more electromagnets of the plurality of the electromagnets and the location of one or more permanent magnets of the plurality of the permanent magnets of the matrix, using one or more parameters. One or more parameters are selected from a group of a location of the user in the virtual environment, a location of 3D object 601 in virtual environment, a position of matrix with respect to a position of the user, a spatial position of the haptic feedback device 104 with respect to the user, and a type of wearable used by the user. The communication device or the VR/AR system may be configured to generate the activation signal based upon determination of the location of one or more electromagnets of the plurality of the electromagnets and the location of one or more permanent magnets of the plurality of the permanent magnets of the matrix.

As shown in the FIG. 6B, the at least one coil associated to each electromagnet 603 corresponding to each cell in the matrix may configured to be activated upon receipt of the activation signal and remaining electromagnets 604 of the matrix are deactivated.

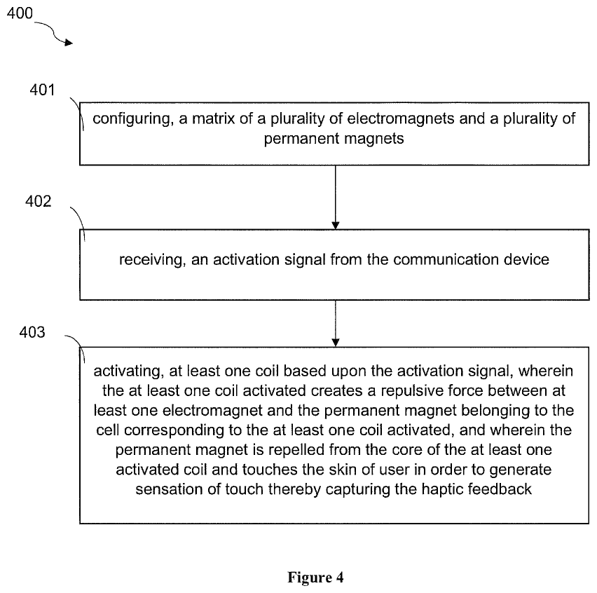

Now referring to FIG. 4, a method 400 for capturing haptic feedback is depicted, in accordance with the first embodiment of the present subject matter.

At step 401, a matrix of a plurality of electromagnets and the plurality of permanent magnets may be provided on the haptic feedback capturing device 104. Each cell in the matrix may comprise of one or more electromagnets 202, of the plurality of electromagnets, and one or more permanent magnets 203 of the plurality of permanent magnets. The matrix may be communicatively coupled with the communication device. In one embodiment, the coil associated to each electromagnet 201 corresponding to each cell in the matrix may comprise of a core 202. The core 202 is made up of a ferromagnetic material for enhancing strength of magnetic field.

At step 402, the haptic feedback capturing device 104 may receive an activation signal from the communication device.

At step 403, the haptic feedback capturing device 104 may activate at least one coil based upon the activation signal. The at least one coil activated may create the repulsive force between at least one electromagnet 201 and the permanent magnet(s) 203 belonging to the cell corresponding to the at least one coil activated. The permanent magnet(s) 203 may be repelled from the core 202 of the at least one activated coil and touches the skin of user in order to generate sensation of touch thereby capturing the haptic feedback.

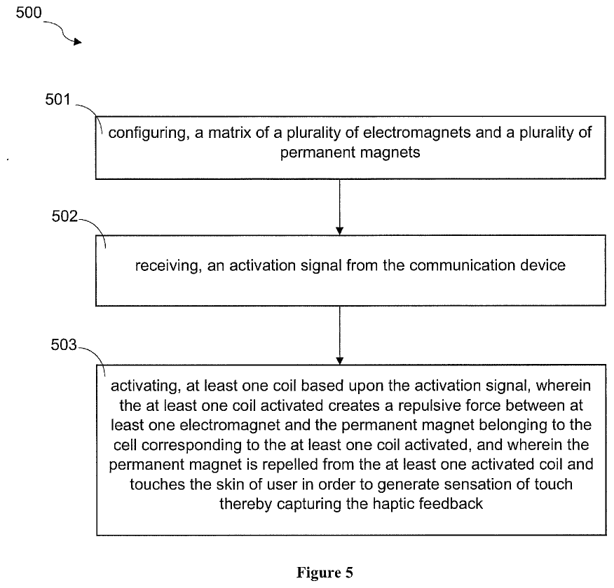

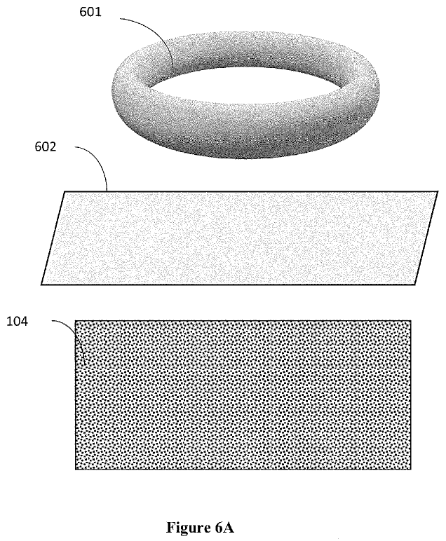

Now referring to FIG. 5, a method 500 for capturing haptic feedback is depicted, in accordance with the second embodiment of the present subject matter.

At step 501, a matrix of a plurality of electromagnets and the plurality of permanent magnets may be provided on the haptic feedback capturing device 104. Each cell in the matrix may comprise one or more electromagnets 301, of the plurality of electromagnets, and the permanent magnet 302 of the plurality of permanent magnets. The matrix may be communicatively coupled with the communication device.

At step 502, the haptic feedback capturing device 104 may receive an activation signal from the communication device.

At step 503, the haptic feedback capturing device 104 may activate at least one coil associated to each electromagnet 301 corresponding to each cell in the matrix based upon the activation signal. The at least one coil activated may create the repulsive force between at least one electromagnet 301 and the permanent magnet 302 belonging to the cell corresponding to the at least one coil activated. The permanent magnet may be repelled from the at least one activated coil and touches the skin of user in order to generate sensation of touch thereby capturing the haptic feedback.

Various exemplary embodiments illustrating applications of the haptic feedback capturing device 104 are described below:

In a first exemplary embodiment, the haptic feedback capturing device 104 comprising a matrix of plurality of electromagnets and plurality of permanent magnets may be implemented into a wearable surface such as hand gloves 104-2, and clothing 104-1, etc. The matrix is communicatively coupled with the Virtual Reality (VR) device 101 or the Augmented Reality (AR) Device 103. One or more gestures performed by the user in the Virtual reality (VR) or AR environment is recognized by the VR device 101 or AR device 103 using the existing methodologies known in the art. The VR device 101 or AR device 103 transmits an activation signal indicative of the touch gesture from a Virtual Reality (VR) device to the haptic feedback capturing device 104. The haptic feedback capturing device 104 is configured to activate the at least one coil based upon the activation signal. The at least one coil activated may create the repulsive force between at least one electromagnet and the permanent magnet belonging to the cell corresponding to the at least one coil activated. The permanent magnet(s) 203 may be repelled from the core 202 of the at least one activated coil (See FIG. 2B) or the permanent magnet 301 may be repelled from the at least one activated coil (See FIG. 3B) and touch the skin of user in order to generate sensation of touch thereby capturing the haptic feedback. In one embodiment, the user may feel the touch or identify the texture or pattern in the Virtual Reality (VR) or Augmented Reality (AR) environment.

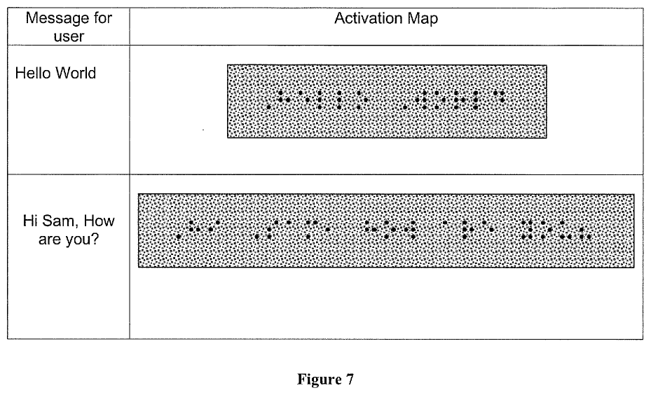

In a second exemplary embodiment, the haptic feedback capturing device 104 comprising a matrix of the plurality of electromagnets and the plurality of permanent magnets may be implemented in a display device 104-3 for displaying braille to braille users. Now referring to FIG. 7, an implementation of the haptic feedback device 104 in a display device for displaying braille to braille users is illustrated. In one embodiment, the display device 104-3 for displaying braille may be dynamic, wherein the display device 104-3 is configured to change the braille letter configuration displayed on the same area. When the display device 104 wants to display something, the one or more electromagnets of the plurality of electromagnets are activated to form braille letters. The dynamic display of braille may allow braille letters to scroll rather than the person reading them having to move their fingers across the area. The dynamic display may allow users to use devices like mobile phones, tablets etc. The display device 104-3 for displaying braille may act as a wearable for blind people, and further provide mobility to them. The haptic feedback capturing device 104 implemented in the display device 104-3 is configured to activate the at least one coil based upon the activation signal indicative of display of braille letter. The at least one coil activated may create a repulsive force between at least one electromagnet 201 and the permanent magnet(s) 203 belonging to the cell corresponding to the at least one coil activated. The permanent magnet(s) 203 may be repelled from the core 202 of the at least one activated coil (See FIG. 2B) or the permanent magnet 302 may be repelled from the at least one activated coil (See FIG. 3B) and touch the skin of the user in order to generate sensation of touch thereby capturing the haptic feedback. In one embodiment, the user may feel the across the display for the bumps of the matrix, thereby being able to read braille letter displayed on the display device 104-3. This display device may also be used to allow users to experience various patterns across its surface like a display area for embossed patterns that can vary based on the activation signals provided.

In a third exemplary embodiment, the haptic feedback device 104 comprising matrix of the plurality of electromagnets and the plurality of permanent magnets may be implemented in a Virtual Reality (VR) video game remote controller 104-4. When there are events in the games such as virtual explosions, bumping into virtual objects etc, the activation signal indicative of such events is transmitted to the haptic feedback device 104. The haptic feedback capturing device 104 may implemented in the VR video game controller 104-4 is configured to activate the at least one coil based upon the activation signal indicative of events in the games. The at least one coil activated may create a repulsive force between at least one electromagnet and the permanent magnet belonging to the cell corresponding to the at least one coil activated. The permanent magnet(s) 203 may be repelled from the magnetic core 202 of the at least one activated coil (See FIG. 2B) or the permanent magnet 302 may be repelled from the at least one activated coil (See FIG. 3B) and touch the skin of user in order to generate sensation of touch thereby capturing the haptic feedback. In one embodiment, the user may feel the virtual explosion, bumping into virtual objects.

Although implementations for haptic feedback capturing device and a method thereof have been described in language specific to structural features and/or methods, it is to be understood that the appended claims are not necessarily limited to the specific features or methods described. Rather, the specific features and methods are disclosed as examples of implementations for the haptic feedback capturing device and a method thereof.

1. A haptic feedback capturing device comprising: a plurality of electromagnets and a plurality of permanent magnets arranged in form of a matrix, wherein each cell, in the matrix, comprises one or more electromagnets, of the plurality of electromagnets, and one or more permanent magnets of the plurality of permanent magnets, and wherein the matrix is communicatively coupled with a communication device, and wherein a coil associated to each electromagnet corresponding to each cell in the matrix comprises a core, and wherein the at least one coil in the matrix is configured to be activated upon receipt of an activation signal from the communication device, and wherein the at least one coil activated creates a repulsive force between the at least one electromagnet and the permanent magnet(s) belonging to the cell corresponding to at least one coil activated, and wherein the permanent magnet(s) is repelled from the core of the at least one activated coil and touches the skin of the user in order to generate sensation of touch thereby capturing the haptic feedback.

2. The haptic feedback capturing device as claimed in claim 1, wherein the permanent magnet(s) is embedded into a wearable surface.

3. The haptic feedback capturing device as claimed in claim 2, wherein the matrix is positioned at same side of the wearable surface, thereby implementing the matrix on at least one of the clothing, handling equipment, interactive surfaces.

4. The haptic feedback capturing device as claimed in claim 1, wherein the communication device is a Virtual reality (VR) device or an Augmented reality (AR) device.

5. The haptic feedback capturing device as claimed in claim 1, wherein the communication device is a display device associated with braille user.

6. The haptic feedback capturing device as claimed in claim 1, wherein the core is made up of ferromagnetic material.

7. The haptic feedback capturing device as claimed in claim 1, wherein one end of the coil associated to each electromagnet is closed and other end of the coil is either touching the skin or close to the skin of the user.

8. The haptic feedback capturing device as claimed in claim 1, wherein variation in an electric current varies the repulsive force and that in turn translates to different amount of pressure sensations at the point of contact.

9. A method for capturing haptic feedback, the method comprising:
configuring, on a haptic feedback capturing device, a matrix of a plurality of electromagnets and a plurality of permanent magnets, wherein each cell in the matrix comprises one or more electromagnets, of the plurality of electromagnets, and one or more permanent magnets of the plurality of permanent magnets, and wherein the matrix is communicatively coupled with a communication device, and wherein a coil associated to each electromagnet, corresponding to each cell in the matrix, comprises a core;
receiving, by the haptic feedback capturing device, an activation signal from the communication device; and
activating, by the haptic feedback capturing device, at least one coil based upon the activation signal, wherein the at least one coil activated creates a repulsive force between at least one electromagnet and the permanent magnet(s) belonging to the cell corresponding to the at least one coil activated, and wherein the permanent magnet(s) is repelled from the core of the at least one activated coil and touches the skin of the user in order to generate sensation of touch thereby capturing the haptic feedback.

10. The method as claimed in claim 9, wherein the core is made up of ferromagnetic material.

11. A haptic feedback capturing device, comprising: a plurality of electromagnets and a plurality of permanent magnets arranged in form of a matrix, wherein each cell in the matrix comprises one or more electromagnets, of the plurality of electromagnets, and one or more permanent magnet(s) of the plurality of permanent magnets, wherein the matrix is communicatively coupled with a communication device, wherein the at least one coil associated to each electromagnet corresponding to each cell in the matrix is configured to be activated based upon receipt of an activation signal from the communication device, and wherein the at least one coil activated creates a repulsive force between the at least one electromagnet and the permanent magnet belonging to the cell corresponding to at least one coil activated, and wherein the permanent magnet is repelled from the at least one activated coil and touches the skin of user in order to generate sensation of touch thereby capturing the haptic feedback.

12. The haptic feedback capturing device as claimed in claim 11, wherein a separation layer is present between the matrix of the plurality of electromagnets and the plurality of permanent magnets, and skin of the user.

13. The haptic feedback capturing device as claimed in claim 11, wherein coil associated to each electromagnet is placed around or at a close distance to each permanent magnet corresponding to respective cell in the matrix closer to the user's skin.

14. The haptic feedback capturing device as claimed in claim 11, wherein the communication device is a Virtual reality (VR) device or an Augmented reality (AR) device.

15. The haptic feedback capturing device as claimed in claim 11, wherein the communication device is a display device associated with braille user.

16. A method for capturing haptic feedback, the method comprising:
configuring, on a haptic feedback capturing device, a matrix of a plurality of electromagnets and a plurality of permanent magnets, wherein each cell in the matrix comprises one or more electromagnets, of the plurality of electromagnets, and one or more permanent magnet(s) of the plurality of permanent magnets, wherein the matrix is communicatively coupled with a communication device;
receiving, by the haptic feedback capturing device, an activation signal from the communication device; and
activating, by the haptic feedback capturing device, at least one coil associated to each electromagnet corresponding to each cell in the matrix based upon the activation signal, wherein the at least one coil activated creates a repulsive force between at least one electromagnet and the permanent magnet belonging to the cell corresponding to the at least one coil activated, and wherein the permanent magnet is repelled from the at least one activated coil and touches the skin of user in order to generate sensation of touch thereby capturing the haptic feedback.
